(19) United States
(12) Patent Application Publication
(10) Pub. No.: US 2010/0011721 A1
(43) Pub. Date: Jan. 21, 2010

(54) AIR FILTER FOR A COMBUSTION MACHINE

(76) Inventors: Friedrich Gruber, Hippach (AT); Gerhard Kathrein, Jenbach (AT); Jurgen Lang, Schwaz (AT)

Correspondence Address: WENDEROTH, LIND & PONACK, L.L.P., 1030 15th Street, N.W.,, Suite 400 East, Washington, DC, 20005-1503, US

(21) Appl. No.: 12/498,693

(22) Filed: Jul. 7, 2009

(30) Foreign Application Priority Data
Jul. 21, 2008 (AT) A 1126/2008

(51) Int. Cl. F02M 35/024; B01D 50/00

(52) U.S. Cl. 55/385.1; 55/482

(57) ABSTRACT

An air filter for a combustion machine including a housing with a flow passage and a filter insert, wherein said filter insert subdivides the flow passage into an intake flow passage with an air inlet opening and into a discharge flow passage with an air outlet opening, wherein the filter insert has an air inlet surface which extends at least region-wise over the length of the filter insert along the air flow direction, wherein said filter insert has at least two successive filter elements, wherein the outside diameter or diameters of said filter elements, is or are different.

The invention concerns a combustion machine having an induction pipe and an air filter. The invention further concerns an air filter for a combustion machine including a housing with a flow passage and a filter insert, wherein the filter insert subdivides the flow passage into an intake flow passage with an air inlet opening and into a discharge flow passage with an air outlet opening. Finally the invention concerns a stationary power installation including a combustion machine and a generator operable by the combustion machine.

Filtering the induction air in the case of combustion machines or internal combustion engines is a generally performed practice which is used practically in relation to any internal combustion engine. Many situations of use involve employing a porous filter for filtering the air, wherein the cross-section of the pores through which the air to be filtered flows are designed in accordance with the required class of filter. Frequently for that purpose use is made of paper cloth or fiber materials which are typically introduced into filter cartridges or suitable holders, more specifically in such a way that, with the smallest possible structural volume, the largest possible through-flow cross-section or a large filter area cross-section is achieved, so that the pressure drop is limited to a tolerable level. The entire functional unit of the filter substantially comprises a housing having an air inlet and an air outlet opening as well as a filter insert integrated in such a way that the air must flow through the filter surface or surfaces. The usual configuration of the air filters is frequently barrel-shaped involving a length/diameter ratio of about two or prism-shaped involving a length/width ratio also of about two.

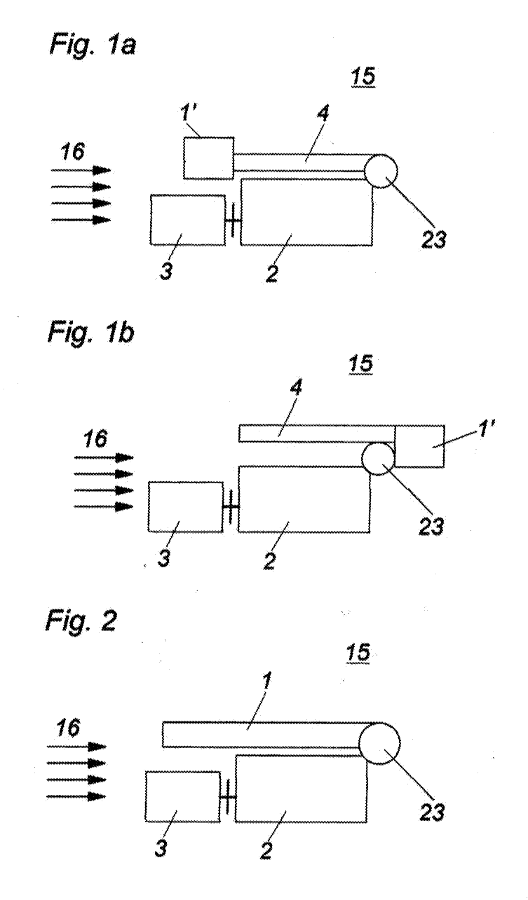

The main components of motor-driven stationary power installations are the combustion machine and a generator, the combustion machine driving the generator to generate power. Disposing such stationary power installations in a machine house is generally such that the generator receives air which is as unheated as possible, to cool the windings. The machine house ventilation is therefore so designed that the generator is arranged first in the direction of flow of the air. In the case of such stationary power installations the generator heats the air cooling it by up to 30° C. The heated generator cooling air or generator exhaust air is mixed downstream with the other air, with thermal radiation from the combustion machine leading to additional heating of the air in the machine house. If the induction pipe for the combustion air of the combustion machine is in an unfavorable position, in particular if induction occurs at the end of the combustion machine, that is opposite to the generator, greatly heated air is fed to the combustion machine, which can cause serious power and efficiency losses, in particular when high outside temperatures prevail. Induction of the combustion air in the case of turbocharged engines takes place at the location of the charger unit which for structural reasons is frequently arranged on the side of the engine, that is remote from the generator. To avoid excessively heated induction air passing to the engine, the air is drawn in by way of a suitable communicating conduit at a suitable location. That leads to structural solutions, as illustrated in FIGS. 1a and 1b.

In accordance with those solutions, there is provided an induction pipe which extends (in opposite relationship to the direction of flow of the air) from the charger unit over the engine and the generator. In that way fresh air which has not been heated by the generator can be fed to the engine. Arranged at the front end of the induction pipe or at the rear end of the communicating pipe, preferably immediately upstream of the charger unit, there is typically an air filter, as described hereinbefore.

That arrangement is relatively complicated and expensive and is found to be disadvantageous in terms of maintenance and repair work. In the case of highly charged combustion machines with a rising increase in power compressor induction noise occurs (referred to as turbocharger howl) so that in many cases additional devices for sound insulation have to be provided.

Therefore the object of the present invention is to provide an air filter and a combustion machine and a stationary power installation of the kind set forth in the opening part of this specification, wherein the described problems including noise emission are reduced.

That object is attained by an air filter for a combustion machine including a housing with a flow passage and a filter insert, wherein the filter insert subdivides the flow passage into an intake flow passage with an air inlet opening and into a discharge flow passage with an air outlet opening, wherein the filter insert has an air inlet surface which extends at least region-wise along the air flow direction, wherein the filter insert has at least two, preferably at least three, successive filter elements, preferably cylindrical tube portions, wherein the outside diameter of the filter elements, preferably cylindrical tube portions is different.

In accordance with the general definition a cylinder is defined by two parallel flat surfaces and a peripheral or cylinder surface formed by parallel straight lines. In other words, a cylinder is produced by the displacement of a flat surface or curve along a straight line which is not in that plane. In this case tubular means that the base and top surface of the cylinder are apertured in the center. The simplest example would be a circular ring surface. In this context however any shape such as for example a circular shape, a polygonal shape, elliptical shapes and irregular shapes can equally be involved as the cylindrical tube.

As the induction pipe, besides air induction, at the same time performs the task of filtering the air, air filtering takes place over a longer distance than is usual in the state of the art. Thus the air filter medium already has a good sound-insulating effect and the noise level can very greatly reduced by the provision of a further insulating layer or absorption layer which is specifically optimized for sound damping in the required frequency range, at the inside wall of the housing.

In conventional air filters with a filter insert of a barrel or prismatic shape, the induction air flows into the air filter at the intake flow side at the air inlet surface and encounters the air inlet surface of the filter insert in frontal relationship, that is to say substantially perpendicularly. After passing through the filter insert the air issues from the filter insert again at the discharge flow passage side, out of the filter insert, and can issue from the air filter by way of the air outlet opening. With a filter insert in which the filter insert has an air inlet surface extending at least region-wise along the air flow direction the noise emission can be reduced as, with such a filter insert, it is not the entire amount of air that has to pass through a filter surface arranged in normal relationship to the flow direction, but can penetrate by way of a larger surface along the flow direction (that is to say laterally) into the filter material or can issue from the filter material. The filter insert comprises at least portion-wise a filter material, along the flow direction. The filter material can be for example a pore filter in which the air to be filtered flows through pores. The filter material can be selected from a given filter class, in dependence on the desired degree of purity of the air. For example it is possible to use paper cloth or fiber materials.

In a preferred variant it can be provided that the cross-sectional area of the intake flow passage changes along the filter insert. By virtue of suitable dimensioning of the cross-sectional area in the intake flow passage and/or in the discharge flow passage, the axial flow speed can be kept substantially constant over the entire air filter, whereby the structural volume and the flow losses can be minimized.

In addition in a preferred variant it can be provided that the cross-sectional area of the intake flow passage becomes smaller along the filter insert in the flow direction. The reduction in that cross-sectional area can take place continuously but also discontinuously, wherein in the discontinuous case the abrupt changes in cross-section become progressively smaller, the greater the number of filter elements. Desirably in the variants where there is a reduction in the cross-sectional area of the intake flow passage, the cross-sectional area no longer increases or increases only immaterially (that is to say only within the limits of manufacturing tolerances), along the filter insert. It can further be provided that the periphery of the filter insert decreases or increases along the air flow direction.

In a preferred variant of the invention it can be provided that the cross-sectional ratio of the intake flow passage to the discharge flow passage changes in the air flow direction along the filter insert in such a way as corresponds to the change in the volume flows in the intake and discharge flow passages, by virtue of air passing across through the filter medium. It can consequently be provided that the cross-sectional area or areas of the discharge flow passage becomes or become larger along the filter insert, preferably to the extent to which the cross-sectional area or areas of the discharge flow passage becomes or become smaller.

In order to permit that in a particularly simple fashion it can be provided that the housing is of a constant inside diameter at least portion-wise in the region of the filter insert.

In a simple variant it can be provided that the filter insert is in the form of a hollow body which is preferably open at the end, wherein the peripheral surface of the hollow body at least region-wise comprises filter material. It can further be provided that the hollow body is of a conical or frustoconical configuration, that is to say it is in the form of a hollow cone open at the end or a hollow truncated cone which is open at an end.

In a particularly preferred embodiment it can be provided that a first filter element, preferably a cylindrical tube portion, is of an outside diameter corresponding to the inside diameter of a following filter element, preferably a cylindrical tube portion. In terms of production engineering it is thus possible in a simple fashion and using simple materials to produce a filter insert, by individual cylindrical tube portions being joined together. As a further consequence it would be possible for the cylindrical tube portions to be fitted one into the other over a region of their length as in that way it would be possible to dispense with fixing means for fixing the cylindrical tube portions. In that way it is possible to use tube portions which are easier to produce than for example a cone or truncated cone. For reasons relating to maintenance procedures however it is desirable if the individual filter elements are dismantleable.

In a further preferred variant it can be provided that on the inside the housing has at least region-wise an insulating material. In that case the insulating material can be applied in the form of a preferably continuous insulating layer. Providing the housing with an insulating material or an insulating layer exhibits in that case a markedly improved action than just a filter insert alone or a insulating layer alone as the cooperation of a filter element with a suitable insulating layer markedly enhances the sound-insulating action.

In a variant it can be provided that the housing is of a substantially tubular configuration, preferably a cylindrical tubular configuration. The cylinder tube shapes already described hereinbefore for the filter insert can also be used here. It can further be provided that the ratio of housing length to housing inside diameter is greater than or equal to four, but preferably greater than or equal to five.

To reduce the pressure loss at the air inlet side, it can desirably be provided that the air inlet opening is larger than the largest housing internal cross-sectional area in the flow direction. In the simplest case the air inlet opening can be a funnel. In regard to manufacturing procedure and also for reasons of space however it is more desirable if the air inlet opening is beveled. Desirably it is provided in all cases that the air inlet opening is provided with a suitable protective grill which alleviates the effect of backfires and protects the filter insert from mechanical damage. In a variant it can be provided that regions of the housing are of a grid configuration to increase the air inlet area. That grid but also the protective grill can also be made from plastic material for cost reasons.

In a variant it can be provided that the filter insert at least portion-wise comprises fiber material, wherein the thickness of the filter material is substantially constant in the flow direction over the entire length insert. In terms of construction and implementation, care should be taken to ensure that substantially all the air passing into the air filter flows through the filter material and cannot flow past the filter material.

Desirably it can be provided that the air inlet opening and the air outlet opening are arranged in the housing on opposite sides. Preferably it can be provided in that respect that the distance between the air inlet opening and the air outlet opening, with respect to the total length of the housing, is at a maximum. The air inlet opening and the air outlet opening can be arranged diametrally.

Further advantages and details of the invention are shown in the following Figures and set forth in the specific description. In drawing in greatly simplified form:

FIGS. 1a and 1b show examples of stationary power installations in accordance with the state of the art,

FIG. 2 shows a combustion machine and a stationary power installation in accordance with the invention, and

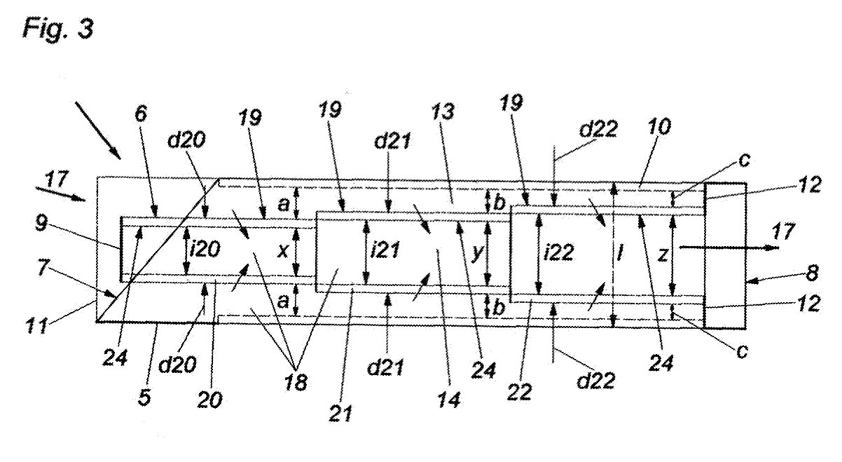

FIGS. 3-6 show views in longitudinal section of four air filters according to the invention.

FIGS. 1a and 1b each show a stationary power installation 15 in accordance with the state of the art which are arranged in a machine house (not shown). The stationary power installation 15 includes a combustion machine 2 and a generator 3, the combustion machine 2 driving the generator 3. By way of example the combustion machine is a gas Otto-cycle engine. As can be seen from FIG. 1a air 16 flows around the generator 3 and the combustion machine 2 (coming from the left-hand side in the plane of the drawing). Now, arranged on the combustion machine 2 is a charger unit 23 in which induction air 16 is compressed. If now the induction air 16 were drawn in directly in the region of the charger unit 23 the hot waste air from the generator 3 would also be drawn in, which could lead to an increase in the temperature of the air drawn in through the induction pipe 4, by up to 20°, so that this would involve a major drop in power output and efficiency at the combustion machine 2. Therefore in accordance with the state of the art there is frequently provided an induction pipe 4 which draws in a part of the unheated induction air 16 so that no waste air from the generator 3 is drawn in. In the FIG. 1a embodiment a conventional air filter 1′ is also connected at an upstream location, which provides for actual intake of the air and which as described hereinbefore filters the air by means of a barrel-shaped or prism-shaped air filter. The air flows through the filter material and is then transferred into the induction pipe 4. In the charger unit 23 the air is compressed for example by way of an exhaust gas-driven compressor device and finally the air is fed to the working cylinders of the combustion machine 2. In the FIG. 1b arrangement the air filter 1′ is arranged downstream of the communicating pipe 4 but upstream of the charger unit 23.

FIG. 2 shows on the one hand a combustion machine 2 and on the other hand a stationary power installation 15 with that combustion machine 2, a generator 3 and a charger unit 23, similarly to the examples of FIGS. 1a and 1b. Now, unlike the state of the art, there is provided an air filter 1 which makes the earlier separately provided air filter 1′ and induction pipe 4 redundant as the air filter is integrated into the induction pipe so that the power installation 15 is more compact or is better accessible in the region of the air filter 1. At the same time the level of noise emission is reduced. The air filter could be constructed as described with reference to FIGS. 2 and 3.

An air filter 1 as is described in FIG. 3 and as is provided in accordance with the invention has a series of advantages of the above-depicted kind, in comparison with the above-discussed situations (FIGS. 1a and 1b). It shows an air filter 1 for a combustion machine, comprising a housing 5 with an air inlet opening 7 and an air outlet opening 8. The region between the air inlet opening 7 and the air outlet opening 8 forms the flow passage 18. Between the air inlet opening 7 and the air outlet opening 8 the housing 5 has a filter insert 6 which subdivides the flow passage 18 into an intake flow passage 13 and a discharge flow passage 14. In accordance with the invention, the part of the flow passage 18 through which air can substantially freely flow is respectively interpreted as the intake flow passage 13 and the discharge flow passage 14, that is to say that part where for example no filter insert 6 is disposed. The air which is drawn in passes in the intake flow passage 13 by way of the air inlet surface 19 into the filter material of the filter insert 6 and leaves the filter material at the air outlet surface 24 so that it passes into the discharge flow passage 14. Then the air passes out of the air filter 1 or the housing 5 by way of the air outlet opening 8.

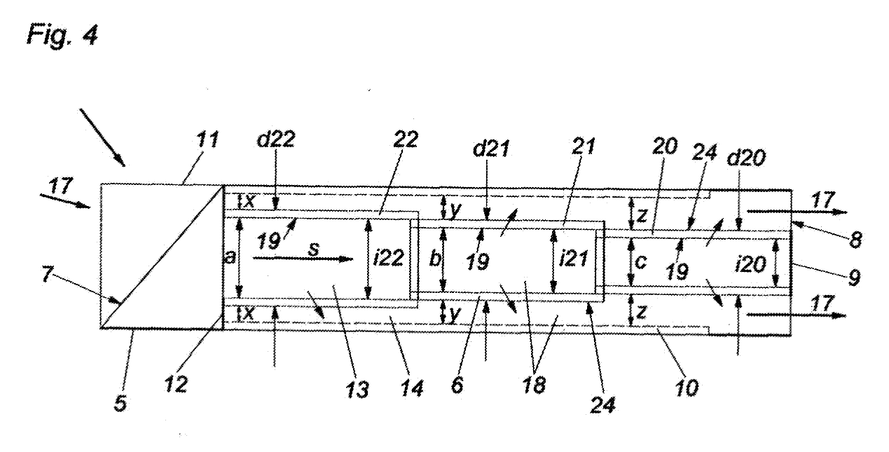

The free cross-sectional area a, b, c of the intake flow passage 13 decreases along the flow direction 17. At the same time the periphery (it will be noted however that only the respective outside diameter d20, d21, d22 is shown) of the filter insert 6 increases along the flow direction s. Conversely, in the illustrated embodiment the free cross-sectional area x, y, z increases in the discharge flow passage 14 in the air flow direction s. Over the longitudinal extent of the filter insert 6 the free cross-sectional area a, b, c of the intake flow passage 13 increases twice. The change in cross-sectional area is discontinuous in the illustrated embodiment, that is to say there is always an abrupt change. Theoretically however the filter insert 6 could also be arranged in the reversed installation position (see FIG. 4). At one side the filter element 6 has a cover 9 so that all the air has to pass through the filter material, that is to say it passes by way of the air inlet surface 19 into the filter material and issues from the filter material at the air outlet surface 24 and cannot flow past the filter material. Instead of a cover 9 however it would also be possible to provide filter material here. On the inside in region-wise fashion the housing 5 has an insulating material or an insulating layer 10. In the illustrated embodiment the housing 5 is of a substantially tubular configuration. In a specific case it can be in the form of a circular cylindrical tube. The air inlet opening 7 is beveled in order in that way to increase the air inlet area 7 in relation to the diameter of the housing 5. The beveled configuration makes it possible to achieve an area increase proportional to 1/cos α. With an angle α of 60° the air inlet area can thus be doubled. As can be seen in combination with FIG. 2, in comparison with the state of the art, with such a configuration, it is possible to dispense with the conventional air filter 1a and the actual air filter 1 can be integrated into the communicating pipe or can be used in place of a conventional communicating pipe 4. Thus it is possible to dispense with a highly space-intensive air filter 1′ and the communicating pipe 4 in the form of an air filter 1 only has to be slightly increased in diameter. That therefore affords a synergistic effect as not only is it possible to dispense with the separate air filter 1′ and the communicating pipe 4, but only a single air filter 1 is used, which at the same time is the communicating pipe 4, and at the same time this also affords sound insulation with the result that the stationary power installation 15 is quieter in operation.

It will be seen from FIG. 3 that the illustrated embodiment has a plurality of filter elements or cylindrical tube portions 20, 21, 22. The filter elements or cylindrical tube portions 20, 21, 22 include filter material (in the illustrated embodiment each filter element 20, 21, 22 comprises filter material). The outside diameter d20 of the filter element or cylindrical tube portion 20 corresponds to the inside diameter i21 of the filter element or cylindrical tube portion 21 so that the two filter elements or cylindrical tube portions 20, 21 can be fitted one into other. That is also clear in the embodiment of FIG. 4. In the FIG. 3 embodiment the portions 20, 21 are fixed by fixing means while in the embodiment of FIG. 4 the portions 20, 21, 22 are fitted one into the other over the length l. The same relationship exists between the cylindrical tube portions 21 and 22 as between the portions 20 and 21, that is to say the outside diameter d21 of the cylindrical tube portion 21 corresponds to the inside tubular diameter i22 of the cylindrical tube portion 22 so that they can be fitted one into the other. Provided at the end of the housing 5 is a holding device 12 which holds the filter insert 6 back. By virtue of the stepwise arrangement of the individual cylindrical tube portions 20, 21, 22 air can systematically pass through the filter element (indicated by the arrows). The amount of filtered air progressively increases in the flow direction s while the unfiltered amount of air progressively decreases in the flow direction s.

The air inlet opening 7 and the air outlet opening 8 in the illustrated embodiment are arranged in opposite relationship in the housing 5, with respect to the longitudinal extent of the housing 5, that is to say diametrally. The distance between the air inlet opening 7 and the air outlet opening 8 is at a maximum in relation to the housing dimensions.

The embodiment of FIG. 4 corresponds to the example of FIG. 3 with the modification that the filter insert 6 is arranged in reverse relationship. In this case also the flow cross-sectional area a′, b′, c′ becomes smaller in the flow direction s along the filter insert 6. The filter insert 6 is fixed to the holding device 12 by means of known holding means. A cover 9 prevents unfiltered air from escaping. Otherwise the individual components will not be referred to in greater detail as they correspond to the example of FIG. 3 so that reference may be directed to the specific description relating thereto.

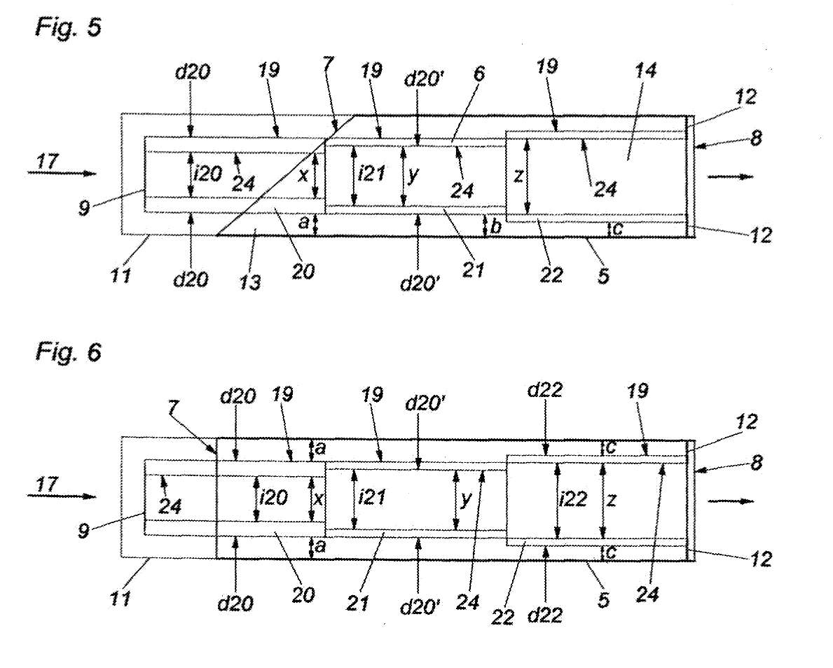

The embodiments of FIGS. 5 and 6 correspond in most points to the example of FIG. 3 so that for reasons of clarity some reference numerals are not shown. FIGS. 5 and 6 also show a respective air filter 1 for a combustion machine. The air filter 1 has in each case a housing 5 with an air inlet opening 7 and an air outlet opening 8. Now, fitted in the flow passage 18 is a filter insert 6 which subdivides the flow passage 18 into an intake flow passage 13 and a discharge flow passage 14 similarly to FIG. 3. The filter insert 6 is made up of a plurality of filter elements 20, 21, 22. In the illustrated embodiment the filter elements 20, 21, 22 are in the form of cylindrical tube portions. In this case also the filter elements 20, 21, 22 could be of different shapes. The example in FIG. 5 differs from the example in FIG. 3 in particular in that the filter insert 6 projects markedly out of the actual housing 5 and the air inlet surface, in comparison with FIG. 3, is arranged displaced in the flow direction 17. A further difference in relation to FIG. 3 is that the filter element 20 is of a greater material thickness than the filter element 20 in FIG. 3 or than the filter elements 21, 22 in the embodiment of FIG. 5. In the illustrated embodiment of FIG. 5 the air inlet opening 7 is covered by an enlarged protective grill 11. Overall that affords an enhanced filter effect as air can already pass through the filter material of the filter element 20, outside the actual housing 5. The larger material thickness of the filter element 20 also provides that the filter effectiveness is increased in that region. In the illustrated embodiment the situation is such that the inside diameter i20 of the filter element 20 is smaller than the inside diameter i21 of the filter element 21. It will be noted however that at the same time the outside diameter d20 of the filter element 20 is substantially equal to the outside diameter d20′ of the filter element 21. That difference also affords the difference in the material thickness of the respective filter elements 20, 21. While the cover grill 11 in the illustrated embodiment is enlarged, in an alternative embodiment it would equally well be possible to provide that the housing is of an air-permeable or grill-like configuration in such a way as is shown in FIG. 5 or FIG. 6. In FIG. 6, unlike FIG. 5, the air inlet opening 7 is no longer beveled but is substantially perpendicular to the air flow direction 17. A most substantial advantage of the variants in FIGS. 5 and 6 over the variant in FIG. 3 or in FIG. 4 is the fact that more air can penetrate into the air filter 1 due to the increase in the size of the air inlet surface and thus the structural length of the air filter can be reduced. In the illustrated embodiments in FIGS. 5 and 6 it is possible in that way to achieve a reduction in the housing length l of 10 to 30 percent, in comparison with that example of FIG. 3. For reasons of clarity, the insulating layer 10 is not shown both in FIG. 5 and also in FIG. 6, but it can also be provided as in the preceding Figures.

In all variants it is advantageously provided that the ratio of the housing length l to the housing inside diameter 18 is greater than or equal to four, preferably greater than or equal to five. In that way the filter efficiency is maximized, with optimum sound insulation. The protective grill 11 could be made for example from a grill mesh of metal which affords a flame-protection function in relation to backfires. Desirably the insulating layer is disposed over at least two thirds of the housing length 17 at the inside of the housing 5, either in the form of a coating or in the form of a lining. With a beveled inlet opening 7 the air is also passed directly onto the sound insulating layer 10 where it can immediately deploy its sound-insulating effect.

1. An air filter for a combustion machine including a housing with a flow passage and a filter insert, wherein said filter insert subdivides the flow passage into an intake flow passage with an air inlet opening and into a discharge flow passage with an air outlet opening, wherein the filter insert has an air inlet surface which extends at least region-wise over the length of the filter insert along the air flow direction, wherein said filter insert has at least two successive filter elements, wherein the outside diameter or diameters of said filter elements, is or are different.

2. An air filter as set forth in claim 1 wherein the cross-sectional area of the intake flow passage changes along the filter insert.

3. An air filter as set forth in claim 1 wherein the cross-sectional ratio of the intake flow passage to the discharge flow passage changes in the air flow direction along the filter insert.

4. An air filter as set forth in claim 2 wherein the cross-sectional area or areas of said intake flow passage becomes or become smaller along the filter insert.

5. An air filter as set forth in claim 1 wherein said housing is of a constant inside diameter at least portion-wise in the region of the filter insert.

6. An air filter as set forth in claim 1 wherein said filter insert is in the form of a hollow body wherein the peripheral surface of the hollow body at least region-wise comprises filter material.

7. An air filter as set forth in claim 6 wherein said hollow body is of a conical or frustoconical configuration.

8. An air filter as set forth in claim 1 wherein said filter elements are connected together by a plug connection, a screw connection or a combination thereof.

9. An air filter as set forth in claim 1 wherein an insulating material is arranged on the inside of said housing.

10. An air filter as set forth in claim 1 wherein the area of the air inlet opening is larger than the housing internal cross-section in the flow direction(s).

11. An air filter as set forth in claim 1 wherein said filter insert comprises fiber material, wherein the thickness of the filter material is substantially constant in the flow direction(s) over the entire length of the filter insert.

12. An air filter as set forth in claim 1 wherein the air inlet opening is covered by a protective grill.

13. An air filter as set forth in claim 1 wherein said filter insert projects region-wise out of the housing in the region of the air inlet surface.

14. An air filter as set forth in claim 1 wherein said at least two successive filter elements are cylindrical tube portions.

15. An air filter as set forth in claim 6 wherein said hollow body is open at the end.

16. A combustion machine including an air filter as set forth in claim 1.

17. A stationary power installation including a combustion machine, a generator operable by the combustion machine and an air filter as set forth in claim 1.
